(19) United States
(12) Patent Application Publication
(10) Pub. No.: US 2013/0135852 A1
(43) Pub. Date: May 30, 2013

(54) TUBE LIGHT STRUCTURE

(71) Applicants: Kam-Kwan Chan, Hong Kong (CN); Wai-Kuen Ng, Hong Kong (CN)

(72) Inventors: Kam-Kwan Chan, Hong Kong (CN); Wai-Kuen Ng, Hong Kong (CN)

(73) Assignee: HONG KONG PATENT EXCHANGE ASSOCIATION LIMITED, Hong Kong (CN)

(21) Appl. No.: 13/812,367

(22) PCT Filed: Feb. 20, 2012
(86) PCT No.: PCT/CN2012/071307

§ 371 Date: Jan. 25, 2013

(30) Foreign Application Priority Data
May 13, 2011 (CN) 201110123371.5

(51) Int. Cl. F21V 29/00; F21V 21/002

(52) U.S. Cl. CPC F21V 29/2293; F21V 21/002
USPC 362/218; 362/221

(57) ABSTRACT

A tube light structure is provided. A tube electrical starting control board is enclosed in an inner space of the outer tube, and the two end portions of the outer tube are respectively disposed with two contact pins for inputting an electrical source to the electrical starting control board; and at least one tube lamp, wherein two end portions thereof are respectively disposed with a fixing part, two fixing pins are respectively disposed on outer part of the fixing part, one of the fixing parts is formed with an input terminal, and the tube electrical starter is inputted the electrical source by a wire passing through the input terminal. Accordingly, the heat-dissipating effect is increased by enlarging the inner space used for accommodating electrical devices, so that the electrical elements are not easily damaged due to poor heat-dissipating.

### TECHNICAL FIELD

The present invention is related to a tube light, and more particularly to a tube light structure in which an inductive operation is changed to an electrical operation and the tube light structure can be applied to the conventional tube light fittings.

### BACKGROUND

A fluorescence tube lamp with two contact pins on both end portions thereof is one of the lighting devices which are widely used around the world. The fluorescence tube lamps are mostly used in the places where illuminance is highly required, such as offices, factories, and hospitals. In the past decade, experimental evidences have been proven that the impedance coils used in the fluorescence tube lamps to constrain gas-discharging is not an optimum lighting solution; however, since the manufacturing cost is low and the structure is simple, the countless fluorescence tube lamps are continuously been used.

The drawbacks of the fluorescence tube light lie in that: when the fluorescence tube light works at the frequency 50 Hz or 60 Hz, the light emitting from the fluorescence tube lamp is flickering and has a stroboscopic effect, which similar to a working machine temporarily stopped. In addition, the efficiency of inductive fluorescent lamp ballasts can't be satisfied because the physic conversion efficiency from a discharge of invisible gas to a visible light can be obviously increased by a nowadays electronic device working in high-frequency through current electronic technology; therefore, for the same lighting efficiency, the process of discharge by using the nowadays electronic device can save a lot of energy. It not only considers costs, but also concern natural resources and environment protections.

Certainly, it not involves the fluorescent lamp ballast cost only for converting the inductive type light fixture to an electronic type light fixture by using a device working in high-frequency. In technical and economical aspects, this kind of conversion is feasible; however, the related works, such as installation, are quite expensive so that it reduces the conversion in progress. It mainly caused by tremendous conversion costs considered by enterprisers or users and environment problems caused by a huge amount of metal frames and ballast after conversions.

As for the above-mentioned problems, a one-piece-formed T85 tube-in-tube energy-saving fluorescence tube lamp is commonly used in markets. It can be directly used in conventional tube light fittings, and comprises at least an energy saving tube lamp with a smaller diameter, an outer tube lamp for enclosing the energy saving tube lamp, and two converters respectively disposed on two end portions of the outer tube lamp. The terminals of the converters are identical to the pins of the conventional fluorescent tube lamp on two end portions thereof. In addition, inside the one or both of the converters is disposed with an electronic ballast consisted of a rectifier and a high-frequency inverter.

Alternately, another kind of energy saving fluorescent tube lamp has a length as the length of the conventional fluorescent tube lamp and is made by an electronic driving device. Inside the energy saving fluorescent tube lamp is disposed with the above-mentioned electronic ballast, and two outer ends of the energy saving fluorescent tube lamp respectively have outer pins. The specification of the outer pins of the energy saving fluorescent tube lamp is in compliance with the specification of the pins on two ends of the conventional fluorescent tube light. Then, an energy saving tube lamp with a smaller diameter is installed in two ends of the electronic driving device.

From above descriptions, in the conventional energy saving tube lamps, the electronic ballast consisted of the rectifier and the high-frequency inverter has to be installed in a small space, so that it will have a difficulty in heat dissipating, which may damage the electronic device. Besides, the tube lamp may not be able to provide maximum lighting due to its compact structure. Moreover, the tube lamp may be damaged due to poor heat dissipating. Therefore, the costs are not reduced but increased due to such drawbacks, and a high failure rate may also bring an inconvenience in use.

### SUMMARY

One objective of the present invention is to provide a tube light structure with a simple structure and can be made with low cost. The tube light structure can be used to replace the conventional fluorescent tube lamp with an economical way and minimum or without extra work, so as to convert the operation of conventional light fixtures into an electronic operation in high frequency.

A tube light structure of the present invention is applied to a fluorescence lamp lighting devices, comprising: a tube electrical starter, comprising an outer tube, and an electrical starting control board, wherein the electrical starting control board is enclosed in an inner space of the outer tube, and two end portions of the outer tube are respectively disposed with two contact pins for inputting an electrical source to the electrical starting control board; and at least one tube lamp, wherein two end portions thereof are respectively disposed with a fixing part, two fixing pins are respectively disposed on outer part of the fixing part, one of the fixing parts is formed with an input terminal, and the tube electrical starter is inputted the electrical source by a wire passing through the input terminal.

In one embodiment, the outer tube of the tube electrical starter has at least one wire for outputting the electrical source to the tube lamp, or the outer tube of the tube electrical starter is formed with at least one output terminal, and the electrical source is outputted by the wire inserted into the output terminal.

In one embodiment, the surface of the outer tube is formed with a plurality of heat-dissipating holes.

In one embodiment, the tube electrical starter is further disposed with a set of battery.

In one embodiment, the tube lamp and the fixing part are detachable.

In one embodiment, the tube lamp is a fluorescence lamp, an energy saving tube lamp having three primary colors and a smaller diameter, cold-cathode fluorescent lamp (CCFL), or a light emitting diode (LED).

The advantages of the present invention lie in that: a proper length of the tube electrical starter according to the present invention can be designed due to a world standard for the length of fluorescence tube lamps, thereby, the tube electrical starter having the electrical starting control board can easily be inserted into a conventional tube light fitting or a light fitting, and more control electrical elements can be further disposed on the electrical starting control board. Accordingly, the heat-dissipating effect is increased by enlarging the inner space used for accommodating electrical devices, so that the electrical elements are not easily damaged due to poor heat-dissipating. Moreover, the electrical elements are detached from the tube lamp; therefore, the tube lamp can have a maximum lighting efficiency and wouldn't easily be damaged so as to save user's cost.

### BRIEF DESCRIPTION OF THE DRAWINGS

FIG. 1 is an exploded view illustrating a tube electrical starter according to an embodiment of the present invention.

FIG. 2 is a perspective view illustrating a tube electrical starter according to an embodiment of the present invention.

FIG. 3 is a cross-sectional view illustrating a tube electrical starter according to an embodiment of the present invention.

FIG. 4 is a perspective view illustrating a tube lamp according to an embodiment of the present invention.

FIG. 5 is a view illustrating the tube electrical starter according to another embodiment of the present invention.

FIG. 6 is a view illustrating the tube electrical starter according to yet another embodiment of the present invention.

FIG. 7 is a view illustrating the tube electrical starter according to still yet another embodiment of the present invention.

FIG. 8 is an applied view of the present invention.

FIG. 9 is another applied view of the present invention.

### DETAILED DESCRIPTION

Now, the preferred embodiment of the present invention will be described in detail with reference to the accompanying drawings.

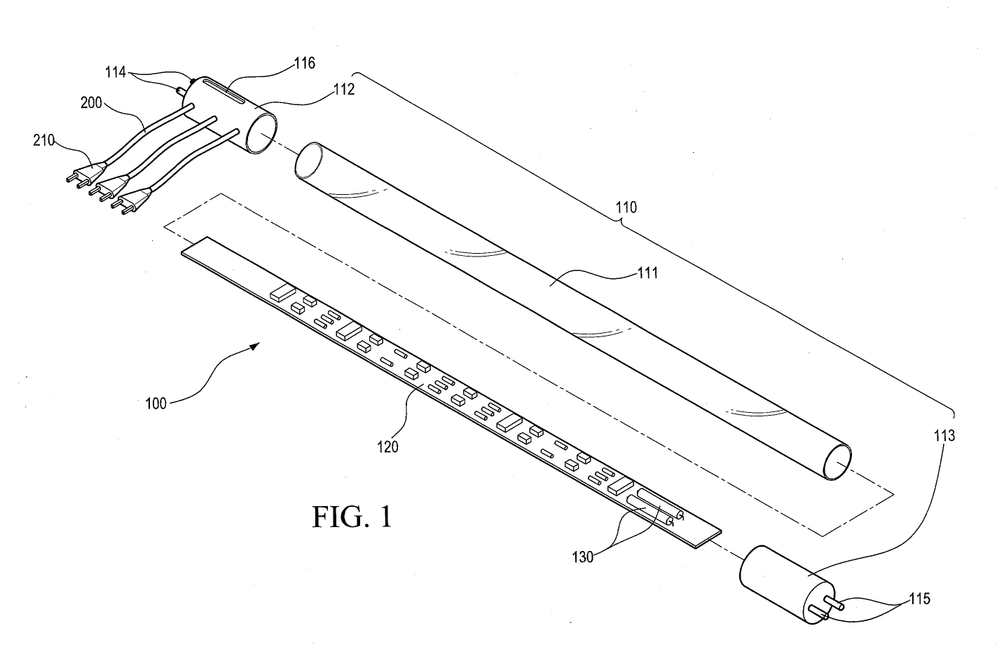

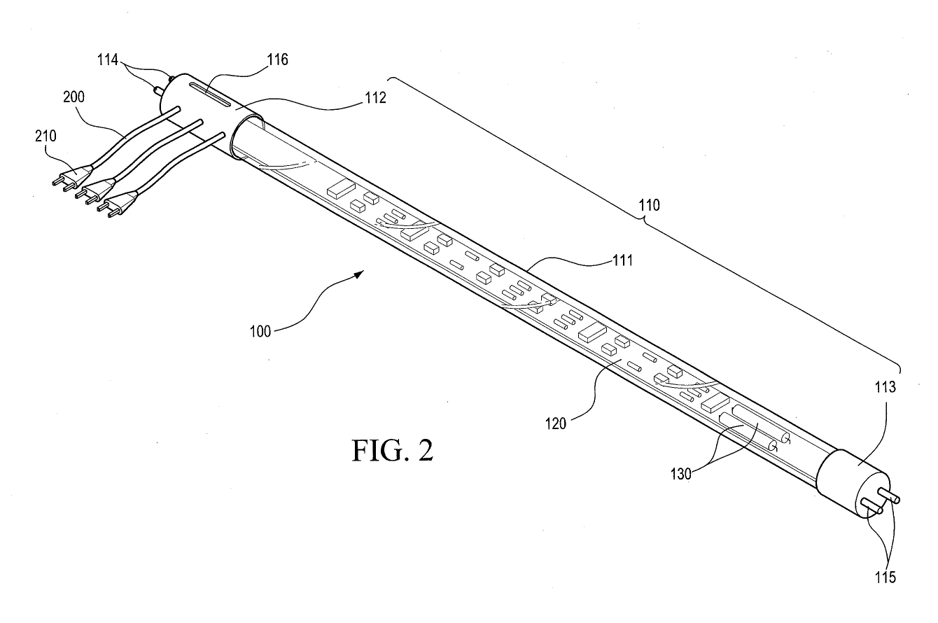

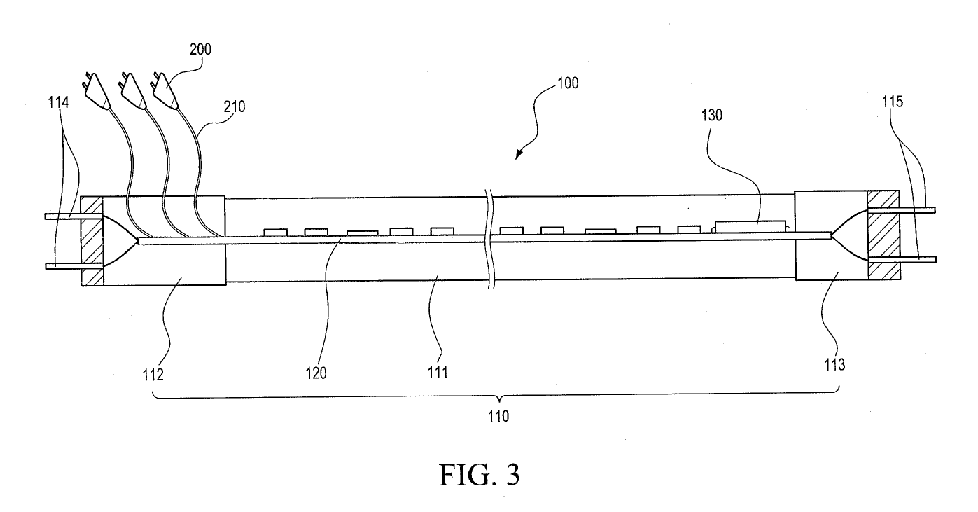

Referring to FIGS. 1, 2, and 3, they are an exploded view, a perspective view, and a cross-sectional view illustrating a tube electrical starter according to an embodiment of the present invention. A tube light structure of the present invention is applied to conventional fluorescence lamp lighting devices with light fittings having lengths of 600 mm, 900 mm, 1200 mm, 1500 mm, and so on.

A tube electrical starter 100 of the present invention, comprises an outer tube 110, and an electrical starting control board 120, wherein the electrical starting control board 120 is enclosed in an inner space of the outer tube 110, and two end portions of the outer tube 110 are respectively disposed with two contact pins 114 [symbol] 115 for inputting an electrical source to the electrical starting control board 120. The electrical starting control board 120 enclosed in the outer tube 110 may be made of glasses, metals, or plastics, so that the electrical starting control board 120 can be protected. The surface of the outer tube 110 is formed with a plurality of heat-dissipating holes 116. The outer tube 110 may be integrally formed or be consisted of a tube body 111 and two end portions 112 [symbol] 113. The heat-dissipating hole 116 is further formed in two end portions 112 and 113 or in one of two end portions 112 and 113. In the embodiment, the heat-dissipating holes 116 formed in the two end portions 112 are used as an example.

The specification of the contact pins 114 and 115 is in compliance with the specification of contact pins on two ends of conventional fluorescence lamps. For example, T8, T10, and T12 specifications of copper pins on the two ends of the fluorescence tube lamp are used to install in a tube light fitting with lengths of 600 mm, 900 mm, 1200 mm, and 1500 mm. The electrical starter control board 120 comprises at least an electrical ballast consisted of rectifiers and high frequency inverters. The electrical starter control board 120 comprises at least an electrical ballast consisted of rectifiers and high frequency inverters. the electrical starting control board 120 is connected to an electrical source through two contact pins 114 [symbol] 115 so as to convert alternate current into high frequency alternate current and provide the high frequency alternate current to one or more than one tube lamp simultaneously. In one embodiment, the electrical starter control board 120 may further disposed with a set of battery 130 so as to provide direct current when block out occurs. In one embodiment, the electrical starting control board 120 may further disposed with an electronic module to control the functions of on/off and bright light/dim light for power saving efficiency. Accordingly, an electronic module may be installed such that the electrical starting control board 120 can have enough electromagnetic compatibility (EMC) to avoid electromagnetic interruptions. In addition, the electrical starting control board 120 is a known technology, so that it will not be described here.

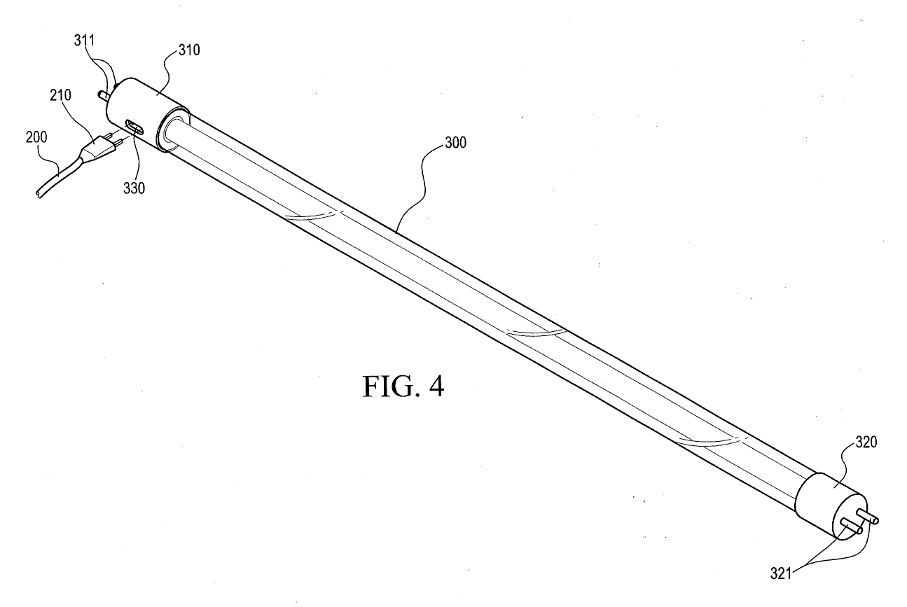

Please refer to FIG. 4, it is a perspective view illustrating a tube lamp according to an embodiment of the present invention. The tube lamp 300 according to the present invention has fixing parts 310, 320 on both end portions thereof, and each fixing part 310 (or 320) is disposed with two contact pins 311, 321. One of the fixing parts 310, 320 is formed with an input terminal 330. A wire 200 ran from the tube electrical starter 100 is inserted into the input terminal 330 for supplying an electrical source. The outer tube 110 of the tube electrical starter 100 has at least one wire 200 for supplying an electric source to the tube lamp 300. In one embodiment, an input end 210 of the wire 200 is inserted into the input terminal 300 so as to provide an electrical source to the tube lamp 300. In addition, the tube lamp may be one of a fluorescence tube lamp, an energy saving lamp having three primary colors and a smaller diameter, a cold-cathode fluorescent lamp (CCFL), and a light emitting diode (LED). In addition, the electrical starting control board 120 is a known technology, so that it will not be described here. Also, an energy saving lamp having three primary colors and a smaller diameter enclosed by a transparent outer tube is used as an example in the drawing.

Moreover, the specification of the contact pins 311, 321 on the fixing parts 310, 320 is in compliance with of the contact pins on both ends of conventional fluorescence lamps. For example, T8, T10, and T12 specifications of copper pins on the two ends of the fluorescence tube lamp are used to install in a tube light fitting with lengths of 600 mm, 900 mm, 1200 mm, and 1500 mm, but the contact pins 311, 321 are used not for conducting but for fixing. In one embodiment, the fixing parts 310, 320 can be detached from the two ends of the tube lamp 300; therefore, only the lighting member is replaced so as to save costs.

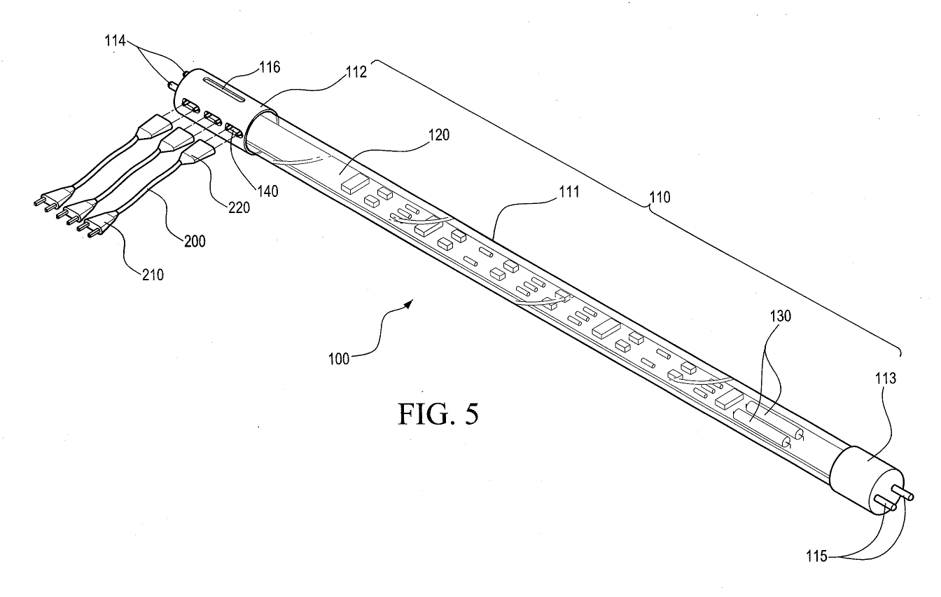

Please refer to FIG. 5, in one embodiment; the outer tube 110 of the tube electrical starter 100 is formed with at least an output terminal 140. As shown in the figure, three output terminals 140 formed on the end portion 112 are used as an example. The output end 220 of the wire 200 is inserted into these output terminals 140 so as to transmit the electrical source to the tube lamp 300.

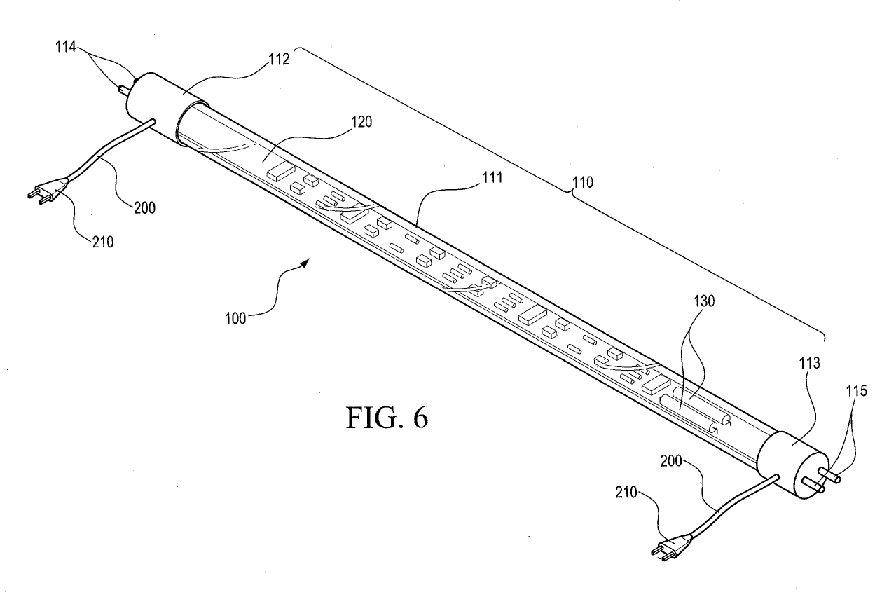

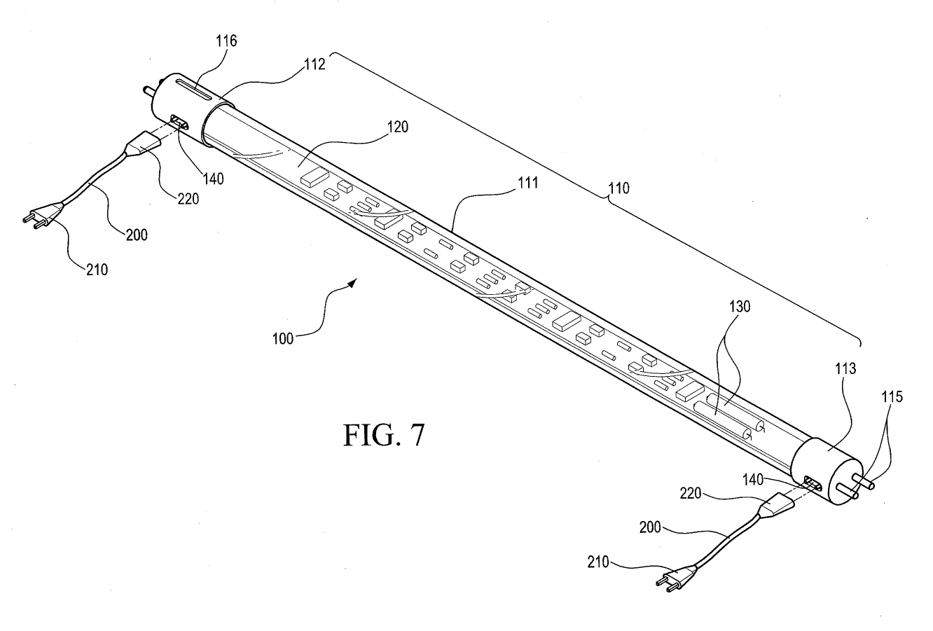

In order to fit actual applications, the wires 200 may directly run from the end portions 112, 113 as shown in FIG. 6 (in the drawing, wires 200 ran from each end portion are used for explanation); the same end portions 112, 113 may be also formed with an output terminal 140, respectively (as shown in FIG. 7), and the output end 220 of the wire 200 is inserted into the output terminal 140 to output the electrical source.

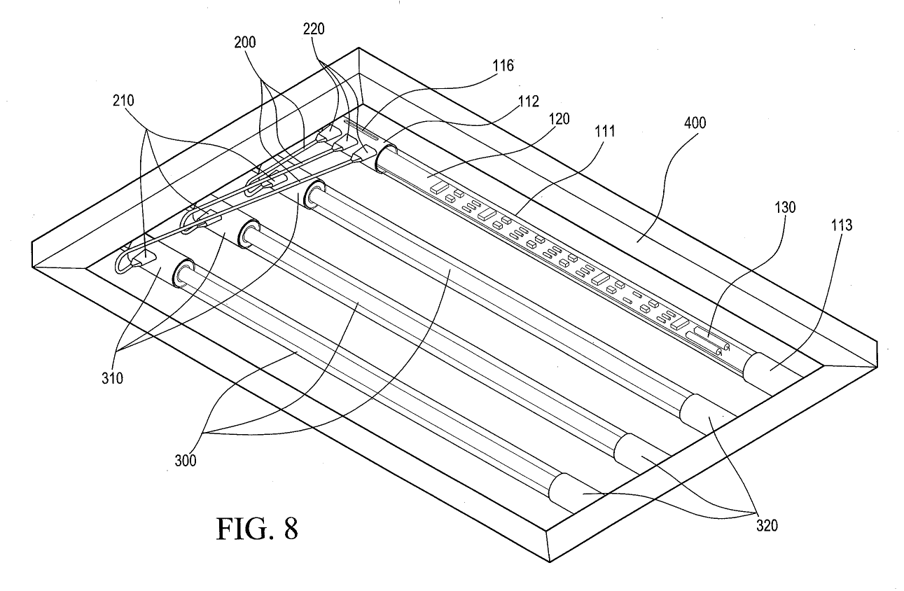

Please refer to FIG. 8, it is the most seen application, and four tube lamp fittings 400 are used as an example. When the tube light structure is applied to a light fixture with four tube lamp fittings 400, a tube electrical starter 100 is installed in one of tube lamp fittings 400 through the contact pins 114, 115 and connected to an electrical source, and another three tube lamp fittings 400 are respectively installed with a tube lamp 300. The tube lamp 300 is fixedly installed through the fixing pins 311, 321, and received the electrical source from the tube electrical starter 100 through the wire 200.

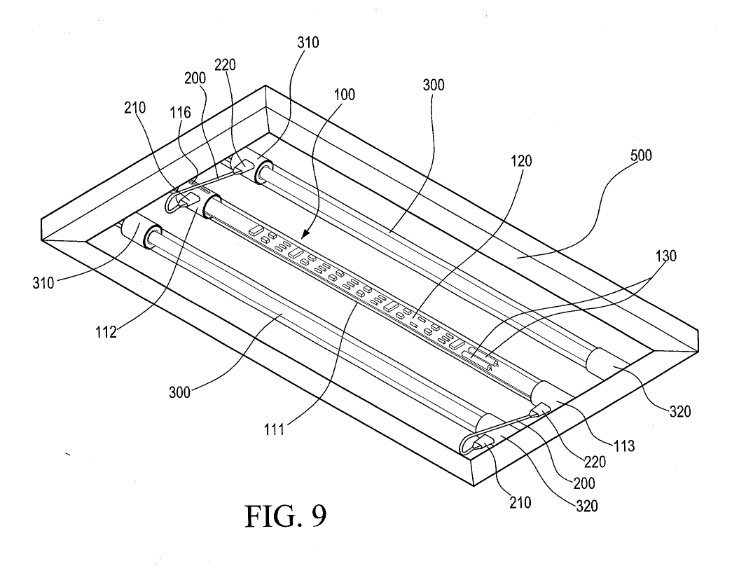

Please refer to FIG. 9, it is another most seen application, and three tube lamp fittings 500 are used as an example. When the tube light structure is applied to a light fixture with three tube lamp fittings 400, a tube electrical starter 100 is installed in the middle tube lamp fittings 400 through the contact pins 114, 115 and connected to an electrical source, and other tow tube lamp fittings 400 are respectively installed with a tube lamp 300. The tube lamp 300 is fixedly installed through the fixing pins 311, 321, and received the electrical source from the tube electrical starter 100 through the wire 200.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A tube light structure for fluorescence lamp lighting devices, comprising:
a tube electrical starter, comprising an outer tube, and an electrical starting control board, wherein the electrical starting control board is enclosed in an inner space of the outer tube, and two end portions of the outer tube are respectively disposed with two contact pins for inputting an electrical source to the electrical starting control board; and
at least one tube lamp, wherein two end portions thereof are respectively disposed with a fixing part, two fixing pins are respectively disposed on outer part of the fixing part, one of the fixing parts is formed with an input terminal, and the tube electrical starter is inputted the electrical source by a wire passing through the input terminal.

2. The tube light structure of claim 1, wherein the outer tube of the tube electrical starter has at least one wire for outputting the electrical source to the tube lamp.

3. The tube light structure of claim 1, wherein the outer tube of the tube electrical starter is formed with at least one output terminal and the electrical source is outputted by the wire inserted into the output terminal.

4. The tube light structure of claim 1, wherein a surface of the outer tube is formed with a plurality of heat-dissipating holes.

5. The tube light structure of claim 1, further the tube electrical starter is further disposed with a set of battery.

6. The tube light structure of claim 1, wherein the tube lamp and the fixing part are detachable.

7. The tube light structure of claim 1, wherein the tube lamp is a fluorescence lamp.

8. The tube light structure of claim 1, wherein the tube lamp is an energy saving lamp having three primary colors and a smaller diameter.

9. The tube light structure of claim 1, wherein the tube lamp is a cold-cathode fluorescent lamp (CCFL).

10. The tube light structure of claim 1, wherein the tube lamp is a light emitting diode (LED).
